(19) United States
(12) Patent Application Publication
(10) Pub. No.: US 2003/0016127 A1
(43) Pub. Date: Jan. 23, 2003

(54) Directional display lamp for a vehicle

(76) Inventor: Tomoaki Imawaki, Fukuoka-Shi (JP)

Correspondence Address: DARBY & DARBY P.C., P. O. BOX 5257, NEW YORK, NY, 10150-5257, US

(21) Appl. No.: 10/202,393

(22) Filed: Jul. 23, 2002

(30) Foreign Application Priority Data
Jul. 23, 2001 (JP) 2001-221401

(51) Int. Cl. B60Q 1/34

(52) U.S. Cl. 340/475

(57) ABSTRACT

The first turn signal lights and the second turn signal lights are located on both sides of the front part and back part of the automobile body. These lights turn on by the operation of a lever provided on a steering wheel. The color of the first turn signal lights is in a hazard notification color, and the color of the second turn signal lights is in a safety notification color. The first turn signal lights and the second turn signal lights are turned on selectively by the operation of the lever. Therefore, when the automobile is turning right or left, because the first turn signal lights and second turn signal lights illuminate in a hazard notification color or a safety notification color, the drivers of all of the other cars can see the moving direction of this car.

### BACKGROUND OF THE INVENTION

1. Field of the Invention

The present invention relates to multiple turn signal lights that are visible on all sides of a vehicle. More specifically, the present invention relates to a plurality of signal lights that are visible on all sides of a vehicle, and emit different colors depending on the situation and this results in driving safety.

2. Discussion of the Related Art

On both sides of the front part and on both sides of the back part of the automobile body, there are turn signal lights which indicate the direction of movement. In general, turn signal lights light up in a hazard notification color such as yellow or orange. When a driver in a driver's seat operates a turn signal lever provided on the steering wheel in the right turning direction or the left turning direction, the turn signal lights on one side light up. Thus, the drivers of the other automobiles such as the facing automobiles and the automobiles in back are forewarned that the automobile is turning and can see the direction of movement (turning right or left). In other words, when turning right, the turn signal lights on the right side turn on, and when turning left, the turn signal lights on the left side turn on.

Referring to FIG. 4, there is a plan view of an uncontrolled intersection. A first automobile A1 is trying to turn left (arrow N1) at the intersection. In addition, a second automobile A2, a third automobile A3, a fourth automobile A4, and a fifth automobile A5 are moving towards the intersection. On both sides of the front part and both sides of the back part of the auto body, each of the automobiles A1-A5 are equipped with a first turn signal light L1, a second turn signal light L2, a third turn signal light L3, a fourth turn signal light L4. The turn signal lights that are actively illuminating are represented by solid black.

As illustrated in FIG. 4, by having the driver of first automobile A1 operate the turn signal lever for left turn N1, on the left side of the auto body, first turn signal light L1 in the front and third turn signal light L3 in the back turn on. Therefore, the drivers in second automobile A2 and third automobile A3 see first turn signal light L1 turned on. In addition, the driver of fifth automobile A5 sees third turn signal light L3 turned on. However, the driver of fourth automobile A4 cannot see first turn signal light L1 and third turn signal light L3 turned on. In other words, the driver of fourth automobile A4 can not judge whether the driver of first automobile A1 is going to turn left as shown in arrow N1 or is going to go straight as shown in arrow N2. If first automobile A1 is turning left (arrow N1), fourth automobile A4 can continue going straight (arrow N3). However, if first automobile A1 is going straight (arrow N2), then the driver of fourth automobile A4 must brake and slow down in order to prevent a collision with first automobile A1.

Similarly, referring to FIG. 4, when first automobile A1 is turning right, second turn signal light L2 and fourth turn signal light L4 turn on, but in this case, the driver of second automobile A2 cannot see the second turn signal light L2 and fourth turn signal light L4 for the same reasons described above. As a result, the driver of second automobile A2 cannot determine whether first automobile A1 is turning right or going straight.

As described above, with the four turn signal lights L1-L4 equipped on the automobile of the prior art, not all of the drivers of the other automobiles could see the direction of movement of an automobile that was turning right or left.

Thus there is still a need in the art for automobile turning lights that will warn drivers in the opposite direction of the turn.

### OBJECT AND SUMMARY OF THE INVENTION

The object of the present invention is to provide a vehicle in which the drivers of all other vehicles can see the direction of movement of a vehicle that is turning left or right at an intersection.

It is the foregoing and various other drawbacks of the prior art which the present invention seeks to overcome by providing a first turn signal light and a second turn signal light that turn on as a result of operation of a lever provided on a steering wheel. The first turn signal and the second turn signal are provided on both of the sides of a front part of a vehicle body. The first turn signal light emits a color that is a hazard notification color and the second turn signal light emits a color that is a safety notification color The first turn signal light and the second turn signal light are turned on selectively by operation of the lever.

When a vehicle is turning right or left, the first turn signal light and the second turn signal light provided on both sides of the front of the vehicle body turn on in a hazard notification color or a safety notification color. As a result, the operators of all other vehicles can see the movement direction of this vehicle.

A second embodiment provides a forward straight signal light provided on a back part of a vehicle body and an operation part, provided inside the vehicle, to turn on the forward straight signal light.

Therefore, when a driver of a first vehicle approaching an intersection operates the operation part and turns on the forward straight signal light, the drivers of all the vehicles behind the first vehicle can see the forward straight signal light and see that the vehicle in front will continue traveling straight.

### BRIEF DESCRIPTION OF THE FIGURES

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1 is a side view of a vehicle illustrating the front and rear turn signals according to one embodiment of the present invention;.

FIG. 2 is a plan view of the vehicle according to FIG. 1;

FIG. 3 is an overhead view of an intersection and the vehicle of the present invention; and

FIG. 4 is an overhead view of an intersection and a prior art vehicle.

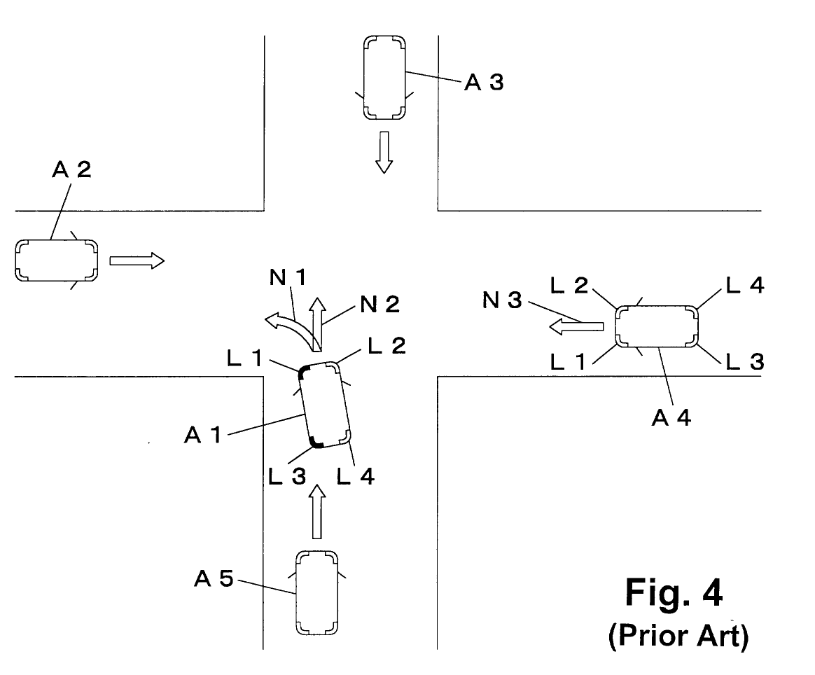

### DETAILED DESCRIPTION OF THE PREFERRED EMBODIMENTS

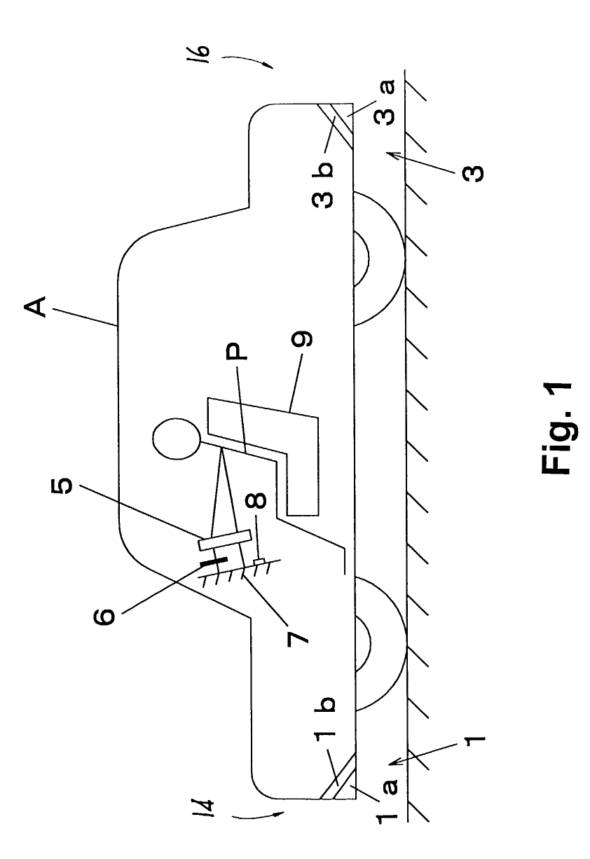

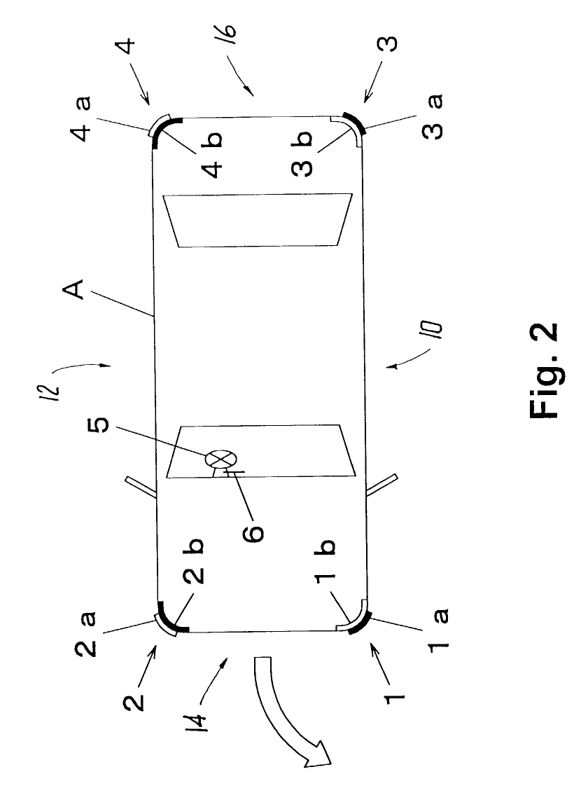

Referring to FIGS. 1 and 2, a first turn signal part 1, a second turn signal part 2, a third turn signal part 3, and a fourth turn signal part 4 are provided on a left side 10 and a right side 12 of both a front part 14 and a back part 16 of a vehicle A. The first, second, third and fourth turn signal parts 1-4 are equipped with first turn signal lights la, 2a, 3a, 4a, and second turn signal lights 1b, 2b, 3b, 4b. First turn signal lights 1a-4a turn on in a hazard notification color such as yellow, orange, or red. Second turn signal lights 1b-4b turn on in a safety notification color such as blue, green or white. In other words, first turn signal lights 1a, 2a, 3a, 4a and second turn signal lights 1b, 2b, 3b, 4b are different colors. Both the first turn signal lights 1a-4a and the second turn signal lights 1b-4b are activated by having a driver P in a driver's seat 9 operate a lever 6 provided on a steering wheel 5 inside the vehicle. The electric circuit for this type of turn signal light can be constructed with known electric circuits by those skilled in the art.

Referring now to FIG. 2, when driver P operates lever 6 for a left turn, on left side 10 of vehicle A, first turn signal light la in front part 14 and turn signal light 3a in back part 16 are illuminated in a hazard notification color. In addition, on right side 16 of vehicle A, second turn signal light 2b in front part 10 and turn signal light 4b in back part 16 are illuminated in a safety notification color.

Referring to FIG. 1, an operation part 8 of a push button or the like is provided near driver 9 in a display panel 7 inside vehicle A. When driver P operates operation part 8, second turn signal lights 1b-4b turn on, and a safety notification color turns on. Second turn signal light 1b, 2b in the front are functioning as a forward straight notification light which communicates to the driver of the opposing automobile in front that vehicle A is moving straight. In addition, second turn signal lights 3b, 4b in the back are functioning as the forward straight notification light which informs the driver of the automobile behind vehicle A that vehicle A is going straight. Operation part 8 is disposed within reach of the hand of driver P, and can be placed anywhere inside vehicle A.

Second turn signal lights 1b-4b can be deactivated by operating operation part 8 again. Second turn signal lights 1b-4b can also be deactivated automatically after an amount of time set by a timer has passed.

### EXAMPLE 1

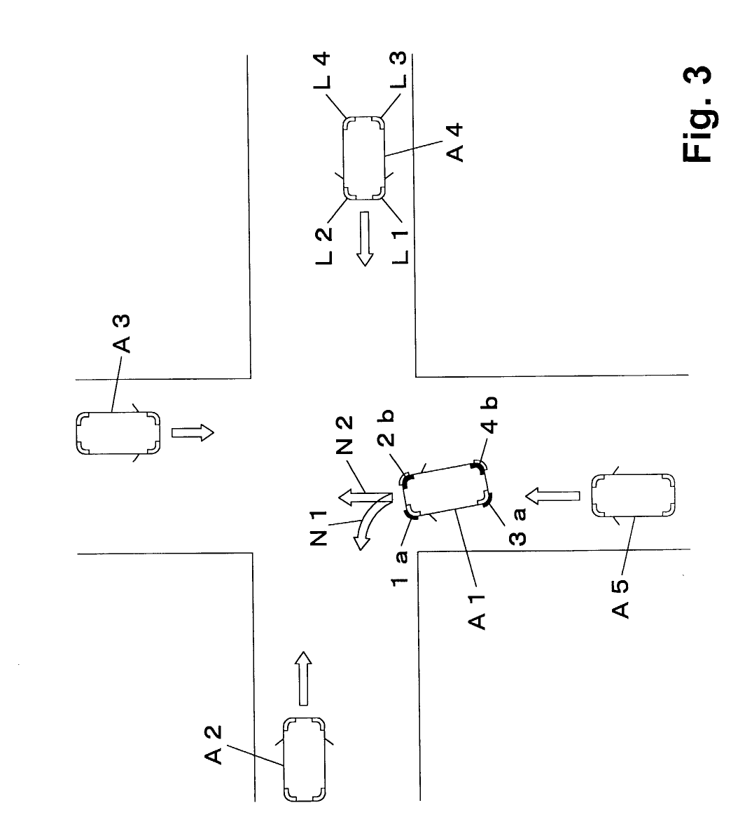

FIG. 3 illustrates a plan view of an uncontrolled intersection. A first automobile A1 is trying to turn left at the intersection (arrow N1). In addition, a second automobile A2, a third automobile A3, a fourth automobile A4, and a fifth automobile A5 are moving towards the intersection.

In the situation shown in FIG. 3, because a driver of first automobile A1 operates lever 6 for a left turn, on left side 10 of auto body a, first turn signal light 1a in front part 14 and first turn signal light 3a in back part 16 illuminate in a hazard notification color. In addition, on right side 12 of auto body A, second turn signal light 2b in front part 14 and second turn signal light 4b in back part 16 illuminate in a safety notification color. Therefore, drivers of second automobile A2 and third automobile A3 see that first turn signal light 1a is illuminated in a hazard notification color. In addition, a driver of fifth automobile A5 sees that first turn signal light 3a is illuminated in a hazard notification color. In addition, the driver of fourth automobile A4 sees that second turn signal light 2b is illuminated in a safety notification color.

As described above, because automobile A1 is equipped with first turn signal lights 1a-4a which selectively light up in a hazard notification color and with second turn signal lights 1b-4b which light up in a safety notification color, the drivers of all of automobiles A2-A5 see the moving direction of automobile A1 as it approaches the intersection.

In addition, referring to FIG. 3, when automobile A1 is moving straight, driver P operates operation part 8. Thereupon, second turn signal lights 1b-4b light up in a safety notification color. As a result, the driver of the opposing automobile in front (third automobile A3) sees second turn signal lights 1b, 2b illuminated and understands that first automobile A1 will not turn right or left at the intersection but will go straight.

In addition, the driver of the automobile behind first automobile A1 (fifth automobile A5) sees second signal lights 3b, 4b illuminated and understands that first automobile A1 will not turn right or left at the intersection but will go straight.

With the present automobile, driving safety is achieved even with T-shaped intersections.

Another embodiment includes operation part 8 being operated, and second turn signal lights 1b, 2b in the front part of the auto body do not have to be illuminated. Thus, when second turn signal lights 1b, 2b only second turn signal lights 3b, 4b in the back of the auto body can be illuminated. With this, only the driver in fifth automobile A5 in back sees that first automobile A1 is going straight.

Wherein the present example is described above in relation to automobiles, those skilled in the art will realize that this invention can be used with any type of vehicle. Motorcycles and all-terrain vehicles (ATVs), which are smaller than automobiles and more difficult to see at night, can benefit greatly from the embodiments of the present invention. When all second turn signal lights are illuminated, they can act as running lights to increase the visibility of the vehicle. Large vehicles including trucks, “18 wheelers”, and buses will also benefit. Another embodiment can include additional side turn signal lights (not illustrated) along the cargo area of the truck. This will allow vehicles along side the truck to be aware of the truck's movements. The most dangerous of situations is where a bus makes a wide turn across a lane of traffic and there is a vehicle along side of the bus. This situation is dangerous because the vehicle may be cut in front of by the bus and the two vehicles collide. A further embodiment includes using the multiple directional display lamps as navigation lights for waterborne vessels. With the increasing popularity of personal water craft (e.g. wet bikes, jet skis) and the owners of the personal water craft less familiar with water navigation rules, multiple directional display lamps increase the visibility of the craft and increase safety.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

What is claimed is:

1. A directional display lamp system for a vehicle comprising:
a first turn signal light having an off position and an illuminated position, wherein said illuminated position displays a hazard notification color;
a second turn signal light having an off position and an illuminated position and disposed proximate to said first turn signal light, wherein said illuminated position displays a safety notification color; and
a lever for selecting said off position and said illuminated position of said first turn signal and said second turn signal.

2. The directional display lamp system as described in claim 1, further comprising:
a vehicle having a left side and a right side, wherein said first turn signal and said second turn signal being disposed on said left side and said right side of said vehicle, wherein said lever comprises:
a left setting wherein said first turn signal disposed on said left side illuminates and said second turn signal disposed on said right side illuminates;
a right setting wherein said first turn signal disposed on said right side illuminates and said second turn signal disposed on said left side illuminates.

3. The directional display lamp system as described in claim 2, wherein said lever further comprises a center setting wherein said second turn signal disposed on said left side and said right side illuminates.

4. The directional display lamp system as described in claim 1, further comprising:
a vehicle having a left side and a right side, a front part and a back part, wherein said first turn signal and said second turn signal being disposed on said left side and said right side of said front part and on said left side and said right said of said back part, wherein said lever comprises:
a left setting wherein said first turn signal disposed on said left side of said front part and said back part illuminates and said second turn signal disposed on said right side of said front part and said back part illuminates;
a right setting wherein said first turn signal disposed on said right side of said front part and said back part illuminates and said second turn signal disposed on said left side of said front part and said back part illuminates; and
a center setting wherein said second turn signal disposed on said left side and said right side of said front part and said back part illuminates.

5. The directional display lamp system as described in claim 1, further comprising an operation part for selecting said off position and said illuminated position of said second turn signal wherein said second turn signal disposed on said left side and said right side illuminates.

6. The directional display lamp system as described in claim 1, wherein said hazard notification color is selected from the group comprising red, yellow and orange.

7. The directional display lamp system as described in claim 1, wherein said safety notification color is selected from the group comprising blue, green and white.

8. The directional display lamp system as described in claim 1, wherein said vehicle is selected from the group comprising cars, trucks, buses, motorcycles, all-terrain vehicles and water craft.

9. An automobile, wherein:
a first turn signal light and a second turn signal light, which turn on as a result of operation of a lever provided on a steering wheel, are provided on each of the sides of a front part of an auto body;
said first turn signal light emits a color that is a hazard notification color;
said second turn signal light emits a color that is a safety notification color;
by operation of said lever, said first turn signal light and said second turn signal light are turned on selectively.

10. An automobile, comprising:
a forward straight signal light provided on a back part of an automobile body;
an operation part, which turns on said forward straight signal light, being provided inside said automobile.
